(19) United States
(12) Patent Application Publication
(10) Pub. No.: US 2010/0280949 A1
(43) Pub. Date: Nov. 4, 2010

(54) CROSS-BORDER OR INTER-CURRENCY TRANSACTION SYSTEM

(75) Inventor: Johannes Janse Van Rensburg, Stellenbosch (ZA)

Correspondence Address: Ballard Spahr LLP, SUITE 1000, 999 PEACHTREE STREET, ATLANTA, GA, 30309-3915, US

(73) Assignee: FUNDAMO (PTY) LTD, Cape Town (ZA)

(21) Appl. No.: 12/740,369

(22) PCT Filed: Oct. 15, 2008
(86) PCT No.: PCT/IB2008/002735

§ 371 Date: Jul. 12, 2010

(30) Foreign Application Priority Data
Oct. 29, 2007 (ZA) 2007/092282

(51) Int. Cl. G06Q 40/00

(52) U.S. Cl. 705/44; 705/39

(57) ABSTRACT

A cross-border financial transaction system is provided in which a local financial institution has a computerised server facility in which multiple system members have each been allocated an account and a foreign financial institution has also been allocated an account and wherein the server facility is programmed to operate a member activated financial transaction system wherein a system member is able to conduct financial transactions by the remote operation of a communications device to transfer money from one financial account in the local financial institution to another financial account. The system is further enabled to reserve funds available in any account during the process of executing a financial transaction initiated by a system member. The server facility is programmed to receive instructions from a system member to execute a cross-border financial transaction; to reserve relevant funds from the instructing system member's account; to communicate information concerning the financial transaction to the said foreign financial institution and to receive a report from the foreign financial institution reporting as to the success, or otherwise of the transaction and transfer the reserved funds appropriately.

### FIELD OF THE INVENTION

This invention relates to a cross-border or, more properly, inter-currency transaction system (herein referred to as a cross-border transaction system), that is particularly suitable for use in the transfer of relatively small amounts of money from a person in one country to another person that is in another country in a simple, inexpensive and rapid manner. Of course, the actual amount of money transferred in each transaction is irrelevant and the amounts of money could equally well be large or small.

More particularly, but not exclusively, the invention relates to cross-border transfers from an account of a payer (who may be the provider of the finance or an interposed agent) held in a financial transaction system that has the general characteristic of real time settlement in one country, to a similar account held by a recipient (who may be the ultimate beneficiary or an interposed agent) in a similar transaction system in another country.

### BACKGROUND TO THE INVENTION

The flow of funds from migrant workers back to their families in their home country is an important source of family income in many developing economies. The relevant payments, frequently referred to as remittances, may generally be considered to be cross-border person-to-person payments of relatively low value.

At present, as far as applicant is aware, there is a dearth of safe, efficient, and suitably inexpensive cross-border transaction systems available to persons wishing to transfer funds to their families or loved ones in another country. Present expedients include entrusting cash to persons travelling between the relevant countries and the use of agencies that are not entirely reliable or trustworthy. Obtaining a bank draft from a commercial bank, or effecting a telegraphic transfer through a commercial bank, requires a greater degree of sophistication of the provider and ultimate beneficiary and, in any event, is generally too expensive bearing in mind the relatively low value of the funds being transferred. Also, use of these present expedients usually involves a significant delay before the funds become available to the beneficiary.

On the other hand, insofar as the national situation is concerned, single currency financial transaction systems that utilise, as at least one possible type of interface, wireless communications devices, typically cellular telephones, for the conduct of financial transactions by remote operation of the communications device, have become more readily available to the public and have been increasing substantially in popularity. Such system may be said to be system member activated transaction systems due to the characteristic that, at least in amongst other transactions, a system member is able to initiate transactions, in particular transfers of funds from that system member's account to an account of another. One such system of particular note is applicant's own system that is known as the FUNDAMO™ payment system in respect of which real time settlement is a significant feature. Such a system is based on that described in our published international patent application number WO/2001/055982 entitled “SYSTEM FOR CONDUCTING COMMERCIAL TRANSACTIONS”.

None of such systems is, as far as applicant is aware, used outside of the particular national environment of its home country for processing relatively low value transactions involving a currency other than the particular national currency of the relevant country.

### OBJECT OF THE INVENTION

It is an object of this invention to provide a cross-border transaction system that exhibits one or more advantages over the cross-border transaction systems mentioned above.

It is another object of the invention to provide a cross-border transaction system in which at least some of the advantages of existing national system member activated transaction systems may be employed in a cross-border transaction system.

### DEFINITIONS

In this specification the following terms are intended to be interpreted as having the following meanings:—
“cross-border financial transaction”
   means an inter-currency financial transaction in which an account debited with funds being transferred in the transaction is maintained with the funds in one currency and the account to be credited with funds is maintained with the funds in a different currency irrespective of any international borders that may or may not be involved;
“reserved” as applied to an amount of money means that the relevant funds are rendered unavailable for any other purpose until such time as they are either transferred to another bank account or the reservation is lifted. Reservation may be achieved either by transferring the amount of money from a first account to a control/holding account, or the amount of money may simply be suitably tagged and identified as being reserved for a particular purpose;
“provider” means the person with whom the amount of money to be transferred originates and who may, but need not necessarily be, a “system member”;
“beneficiary” means the final person to whom the amount of money is to be transferred for that person's use and who may, but need not necessarily be, a “system member”;
“agent” means a person who may be interposed between the provider or beneficiary and the relevant financial institution and who is necessarily a “system member”;
“system member” means a person having the necessary facility available to conduct financial transactions within a member activated financial transaction system by the remote operation of a communications device to transfer money from one financial account in a financial institution to another financial account;
“person” includes both natural persons and legal persons;
“member activated financial transaction system”
   means a financial transaction system in which at least one variety of financial transaction that can be carried out is one in which a system member is able to conduct financial transactions by the remote operation of a communications device to transfer money from one financial account in a financial institution to another financial account by way of a so-called “push” type of transaction being one in which the payer initiates the transaction;
“account” means a set of data typically maintained in a data base record in which transactions, balances, and other information of a particular system member are maintained and which may be said to be that system member's account.

### SUMMARY OF THE INVENTION

In accordance with one aspect of this invention there is provided a cross-border financial transaction system comprising a local financial institution having a computerised server facility containing accounts of multiple system members, and an account of a foreign financial institution, and a communications facility whereby the server facility is enabled to send and receive communications between itself and the foreign financial institution, wherein the server facility is enabled to operate a member activated financial transaction system wherein a system member is able to conduct financial transactions by the remote operation of a communications device to transfer money from one financial account in the local financial institution to another financial account and wherein the system includes a funds reservation facility to reserve funds available in any account during the process of executing a financial transaction initiated by a system member, the cross-border financial transaction system being characterised in that the server facility is enabled to receive instructions from a system member to execute a cross-border financial transaction and for such purpose the server facility includes a funds reservation facility for reserving relevant funds from an instructing system member's account; a send facility for communicating information concerning the financial transaction by way of the communications facility to the said foreign financial institution; a receive facility for receiving a report from the foreign financial institution by way of the communications facility as to the success, or otherwise of the transaction; and a control facility for transferring reserved funds to the credit of the account of the foreign financial institution in the event that the report confirms transfer of the relevant funds in the relevant foreign currency to the beneficiary, and for cancelling the reservation of the funds or returning the reserved funds to the account of the instructing system member in the event that the report reports that the funds were not transferred to the beneficiary, as may be appropriate.

In accordance with another aspect of this invention there is provided a cross-border financial transaction system comprising a local financial institution having a computerised server facility in which multiple system members have each been allocated an account and a foreign financial institution has also been allocated an account, and a communications facility whereby the server facility is enabled to send and receive communications between itself and the foreign financial institution, wherein the server facility is programmed to operate a member activated financial transaction system wherein a system member is able to conduct financial transactions by the remote operation of a communications device to transfer money from one financial account in the local financial institution to another financial account and the system is enabled to reserve funds available in any account during the process of executing a financial transaction initiated by a system member, the cross-border financial transaction system being characterised in that the server facility is programmed to receive instructions from a system member to execute a cross-border financial transaction; to reserve relevant funds from the instructing system member's account; to communicate information concerning the financial transaction to the said foreign financial institution; to receive a report from the foreign financial institution reporting as to the success, or otherwise of the transaction; and, in the event that the report is positive in that it confirms transfer of the relevant funds in the relevant foreign currency to the beneficiary, then to transfer the reserved funds to the credit of the account of the foreign financial institution, and, in the event that the report is negative in that it reports that the funds were not transferred to the beneficiary, then to cancel the reservation of the funds or return the reserved funds to the account of the instructing system member, as may be appropriate.

Further features of the invention provide for the server facility to be programmed to send, in response to the receipt of an instruction to conduct a cross-border financial transaction, a transaction summary to the instructing system member requiring confirmation that the transaction should proceed prior to communicating information concerning the financial transaction to the foreign financial institution, such confirmation typically requiring input of the system member's PIN (personal identification number); for the instructing system member to be either the provider itself or an agent acting on behalf of the provider; for the reservation of the funds to be effected by transferring the funds from the instructing system member's account to a control or holding account from where it is subsequently either transferred to the account of the foreign financial institution or is returned to the instructing system member's account, as the case may be and according to the report received from the foreign financial institution; for the quantum of foreign currency payment to the beneficiary to be calculated at an exchange rate agreeable to the foreign financial institution with the exchange rate optionally being based on a specific real exchange rate at a specific time adjusted to provide a suitable margin for the financial institutions; and for the communications devices employed by at least a majority of the system members to be mobile, typically cellular, telephones.

As a general rule the foreign financial institution will set up a cross-border funding account in its server facility and that funding account is debited during conduct of the transaction indicated above prior to a positive report being sent back to the national financial institution once the beneficiary has received the foreign currency funds.

It is preferred that the cross-border financial transaction system according to the invention be employed between a national financial institution and a foreign financial institution that both operate mutually compatible member activated financial transaction systems, preferably substantially similar systems.

As in the instance of the national financial institution, the beneficiary may be a system member of the foreign financial institution or, alternatively, the beneficiary may receive the funds by way of an agent who is a system member of the foreign financial institution.

In the event that a two-way facility is to be provided the national financial institution will typically set up a funding account in its server facility that is to be debited in consequence of transactions that may take place in the reverse direction, and the national banking institution will be allocated an account to receive funds in the server facility of the foreign banking institution. In each instance, the foreign banking institution's account in the national banking institution and the national banking institution's account in the foreign banking institution that are operated independently of each other, will accumulate funds from multiple cross-border transactions in the relevant direction. Such accumulated funds can be disbursed in any manner that the relevant financial institution desires including by a sale of the accumulated currency and the purchase of any required currency in exchange, typically the currency of the financial institution that is in credit.

In accordance of a second aspect of the invention there is provided a method of conducting cross-border financial transactions utilising a system as defined above in a procedure that will be quite apparent from the aforegoing and as is more fully set out below and defined in the claims.

In order that the above and other features of the invention may be more fully understood, a more detailed description of one embodiment thereof now follows with reference to the accompanying drawing.

In order that the invention may be more fully understood one particular implementation of the invention will now be described with reference to the accompanying drawings.

### BRIEF DESCRIPTION OF THE DRAWINGS

In the drawings:—

FIG. 1 is a diagram illustrating a cross-border transaction system according to the invention in which national and foreign banking institutions have reciprocal facilities; and,

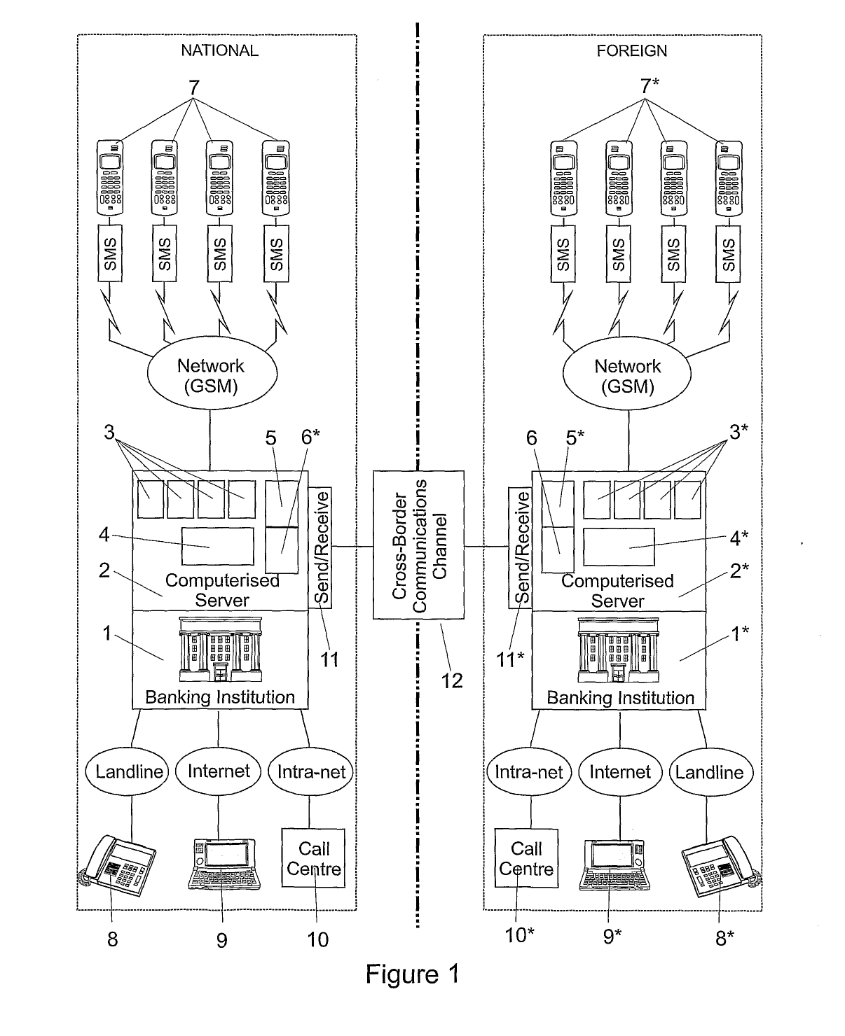

FIG. 2 illustrates schematically the progress of a cross-border transaction being carried out from a national provider to a foreign beneficiary utilizing the system.

### DETAILED DESCRIPTION WITH REFERENCE TO THE DRAWINGS

In the embodiment of the invention illustrated in the drawings, a cross-border financial transaction system comprises a local financial institution in the form of a local banking institution (1) having a computerised server facility indicated by numeral (2) in which multiple system members have each been allocated an account (3). The server facility is programmed to operate a member activated financial transaction system, in this instance, our own real-time transaction system known as the FUNDAMO™ payment system. The server is also programmed to provide the facility to reserve funds available in any of the system member's accounts during the process of executing a financial transaction initiated by a system member by transferring the relevant funds to a control account (4). The server facility has associated with it a communications facility (11) for sending and receiving communications to and from a foreign banking institution (1*) as set out below, the communications being sent by way of a cross-border communications channel (12) typically of a wireless network, but optionally also by any other means such as satellite communications or land line.

In the preferred implementation of the cross-border financial transaction system a similar but foreign banking institution (1*) that mirrors all of the components of the local system is bound by agreements to the local financial institution and for the purpose of explanation the various components of the foreign banking institution are indicated by like numerals with an added *. Thus the foreign transaction system includes a computerised server facility (2*); system member accounts (3*); a control account (4*) and a communications facility (11*).

For the purpose of exercising this invention, the foreign banking institution is allocated an account (5) in the server facility (2) of the local banking institution (1) and the foreign banking institution sets up a funding account (6) in its server facility (2*). In the event that cross-border financial transactions are to be conducted in the reverse direction, the local banking institution is allocated an account (5*) in the foreign banking institutions server facility (2*) and sets up a funding account (6*) in its own server facility (2).

For purposes of clarity the further description will be directed at the conduct of a transfer of funds from a system member's account of the local banking institution to a system member's account of the foreign banking institution. It will be understood that a flow of funds in the reverse direction may equally well take place in an exactly analogous manner. Also, the following description combines a description of the system and of the method.

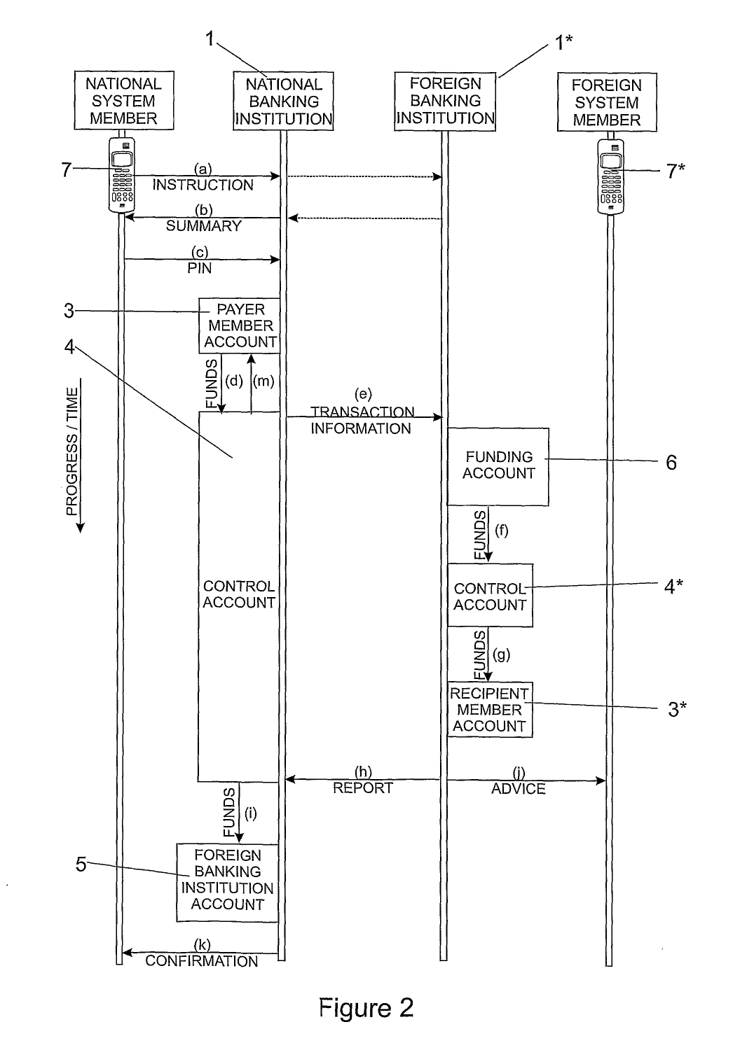

The server facility (2) of the local banking institution (1) is programmed to receive instructions from a system member to execute a cross-border financial transaction to credit an account of a system member of the foreign banking institution (1*). The step is indicated as step (a) in FIG. 2. The programming is such that the server facility, upon receipt of an appropriate instruction, inspects the instructing system member's account to establish that the necessary funds are available.

The server facility of the local banking institution then calculates the foreign currency that represents the local currency amount to be transferred at an exchange rate that is agreeable to the foreign banking institution. Such an exchange rate is generally based on a predetermined published real-time exchange rate at a given time with an allowance for the banking institutions being built in. All other pertinent information is also calculated at the same time.

The server facility may then communicate with the foreign banking institution to establish that the funding account (6) has the credit facility to execute the requested transaction.

Thereafter a transaction summary is communicated back to the instructing system member in order to obtain confirmation that the transaction should proceed. The step is indicated as step (b) in FIG. 2.

Such a transaction summary would typically include the following items:—

The public exchange rate used as a basis.
The exchange rate to be applied to the transaction.
The cost to the instructing system member.
The cost to the recipient system member.
The total cost.
The amount to be debited to the instructing system member's account.
The amount in foreign currency to be credited to the beneficiary's account.
The expected delay (typically in real time but possibly of the order of an hour or so) before the beneficiary's account is expected to be credited.

The communication to the instructing system member preferably requires clearance to proceed, typically by the instructing system member inputting a PIN number. The step is indicated as step (c) in FIG. 2.

Upon receipt of the confirmatory PIN number, the local financial institution's server facility (2) reserves the relevant funds by transferring them from the instructing system member's account (3) to the control account (4) of the local banking institution. The step is indicated as step (d) in FIG. 2.

Information concerning the financial transaction is then communicated to the server facility (2*) of the foreign banking institution (1*), this information matching the information contained in the summary and communicated to the instructing system member in step (b). This step is indicated as step (e) in FIG. 2. The foreign banking institution firstly checks to see that the recipient or beneficiary details are in order. Thereafter it transfers the relevant funds in foreign currency, its currency of operation, from the funding account (6) to its control account (4*) (the step is indicated as step (f) in FIG. 2) and thence to the recipient system member's account (3*) (the step is indicated as step (g) in FIG. 2).

At this stage, the foreign server facility generates a report as to the success, or otherwise of the transaction and the report is communicated to the local banking institution. The step is indicated as step (h) in FIG. 2. In the event that the report is positive and confirms transfer of the relevant funds in the relevant foreign currency to the recipient or beneficiary, the reserved funds held in the control account of the local banking institution are transferred to the credit of the account (5) of the foreign financial institution. The step is indicated as step (i) in FIG. 2. The beneficiary generally receives an advice of the transaction indicated as step (j) in FIG. 2 and the national system member receives a transaction confirmation indicated as step (k) in FIG. 2. The advice may include all the information contained in the transaction summary of step (b).

It will be understood that, in the event that the transaction is, for any reason unsuccessful insofar as the foreign banking institution is concerned, that is to say the report is negative, the reservation of the funds in the national financial institution's control account (4) is cancelled and the funds are returned to the account (3) of the instructing system member as indicated by step (m) and the system member is advised accordingly.

As indicated above, the instructing system member may be either the provider itself or an agent acting on behalf of the provider and the recipient may be beneficiary itself or an agent acting on behalf of the beneficiary. In each instance in which an agent is involved suitable protective measures are employed to ensure that the funds arrive at the correct destination and conform to all applicable laws.

It will be apparent that the foreign financial institution's account in the national financial institution may accumulate the funds from multiple cross-border transactions. Such an accumulation can be disbursed in any manner that the foreign financial institution desires including the sale of the national currency accumulated and purchase of any required foreign currency, typically the foreign currency of that foreign financial institution and any such transaction will be quite independent of the system provided by this invention

It will be understood that many different communications devices can be employed and, most commonly, cellular telephones indicated by numeral (7, 7*) are most appropriately employed in a system such as that indicated above although a telephone (8, 8*) may be used by way of land line; a computer (9, 9*) by way of the Internet; or a call centre (10, 10*) by way of an intranet, can also be used to effect that transactions in a manner that will be quite apparent to those skilled in the art.

It is to be noted that the use of telephones and telephone numbers for identifying target system member's accounts, can automatically cause the transaction to be routed to the relevant country by virtue of the existence of the country code that may form part of the telephone number, and therefore part of the account identification number used in the member activated financial transaction system.

Exercise of this invention can negate the need for a formal “interbank settlement process” as part of the cross-border payment process. In overall effect, there is simply a transfer of funds from the funding account (6) of the foreign financial institution to the foreign banking institutions account (5) allocated to in the national banking institution's server facility with the overall assets in foreign financial institution remaining the same. Settlement takes place as a result of bilateral setup arrangements between the banking institutions with each of the two currencies involved being settled in commercial bank money in the relevant banking institution without any actual exchange and each can be managed quite independently of the member activated payment process.

The foreign banking institution has an exposure in terms of the foreign exchange balance its own currency in the funding account, and this exposure is determined by the exchange rate to which the foreign banking institution has agreed and which is based on a market related reference rate and a margin determined by the beneficiary bank, as indicated above. The foreign banking institution can limit this exposure by setting daily limits (and thresholds) on this exposure.

It is to be noted that there is no cross-border charge structure or interchange fees payable. It is envisaged that in the system of this invention an instructing system member will only be charged for services rendered by the national banking institution or member activated financial transaction system whilst the beneficiary will only pay for charges incurred in the foreign banking institution or member activated financial transaction system.

As regards the processing time, the system of the invention described above is based on real-time processing of each individual transaction and the transaction summary sent to the instructing system member indicates the time frame that can reasonably be expected for delivery to the beneficiary (funds in his account); for example in real time but possibly within an hour. The providers and beneficiaries thus have access to cross-border payments substantially in real-time, based on credit push principles and with a minimum of risks. The process is transparent and has adequate consumer protection. It is also inexpensive when compared to formal transfers taking place by way of bank drafts and telegraphic transfers.

The establishment of the cross-border payment system of the invention is based on a bilateral arrangement as opposed to a multilateral arrangement, which is usually more cumbersome to establish. Furthermore, the initiative to establish a cross-border arrangement lies with the banking institution.

Numerous variations can be made to the system described above without departing from the scope hereof.

1. A cross-border financial transaction system comprising a local financial institution having a computerised server facility containing accounts of multiple system members, and an account of a foreign financial institution, and a communications facility whereby the server facility is enabled to send and receive communications between itself and the foreign financial institution,
wherein the server facility is enabled to operate a member activated financial transaction system wherein a system member is able to conduct financial transactions by the remote operation of a communications device to transfer money from one financial account in the local financial institution to another financial account
and wherein the system includes a funds reservation facility to reserve funds available in any account during the process of executing a financial transaction initiated by a system member,
wherein the server facility is enabled to receive instructions from a system member to execute a cross-border financial transaction and for such purpose the server facility includes a funds reservation facility for reserving relevant funds from an instructing system member's account;
a send facility for communicating information concerning the financial transaction by way of the communications facility to the said foreign financial institution;
a receive facility for receiving a report from the foreign financial institution by way of the communications facility as to the success, or otherwise of the transaction;
and a control facility for transferring reserved funds to the credit of the account of the foreign financial institution in the event that the report confirms transfer of the relevant funds in the relevant foreign currency to the beneficiary, and for cancelling the reservation of the funds or returning the reserved funds to the account of the instructing system member in the event that the report reports that the funds were not transferred to the beneficiary, as may be appropriate.

2. A cross-border financial transaction system comprising a local financial institution having a computerised server facility in which multiple system members have each been allocated an account and a foreign financial institution has also been allocated an account, and a communications facility whereby the server facility is enabled to send and receive communications between itself and the foreign financial institution,
wherein the server facility is programmed to operate a member activated financial transaction system wherein a system member is able to conduct financial transactions by the remote operation of a communications device to transfer money from one financial account in the local financial institution to another financial account
and the system is enabled to reserve funds available in any account during the process of executing a financial transaction initiated by a system member,
wherein the server facility is programmed to receive instructions from a system member to execute a cross-border financial transaction; to reserve relevant funds from the instructing system member's account; to communicate information concerning the financial transaction to the said foreign financial institution; to receive a report from the foreign financial institution reporting as to the success, or otherwise of the transaction; and,
in the event that the report is positive in that it confirms transfer of the relevant funds in the relevant foreign currency to the beneficiary, then to transfer the reserved funds to the credit of the account of the foreign financial institution, and,
in the event that the report is negative in that it reports that the funds were not transferred to the beneficiary, then to cancel the reservation of the funds or return the reserved funds to the account of the instructing system member, as may be appropriate.

3. A cross-border financial transaction system as claimed in claim 2 in which the server facility is programmed to send, in response to the receipt of an instruction to conduct a cross-border financial transaction, a transaction summary to the instructing system member requiring confirmation that the transaction should proceed prior to communicating information concerning the financial transaction to the foreign financial institution.

4. A cross-border financial transaction system as claimed in claim 3 in which the confirmation requires the input of a relevant system member's PIN.

5. A cross-border financial transaction system as claimed in claim 2 in which the system member is selected from the provider itself and an agent acting on behalf of the provider.

6. A cross-border financial transaction system as claimed in claim 2 in which the reservation of the funds is effected by transferring the funds from the instructing system member's account to a control or holding account from where it is subsequently either transferred to the account of the foreign financial institution or is returned to the instructing system member's account, as the case may be and according to the report received from the foreign financial institution.

7. A cross-border financial transaction system as claimed in claim 2 in which the quantum of foreign currency payment to the beneficiary is calculated at an exchange rate agreeable to the foreign financial institution with the exchange rate being based on a specific real exchange rate at a specific time adjusted to provide a suitable margin for the financial institutions.

8. A cross-border financial transaction system as claimed in claim 2 in which the communications devices employed by a majority of the system members are mobile telephones.

9. A cross-border financial transaction system as claimed in claim 2 in which the foreign financial institution has a cross-border funding account in its server facility and that funding account is debited during conduct of the transaction prior to a positive report being sent back to the national financial institution and once the beneficiary has received the foreign currency funds.

10. A cross-border financial transaction system as claimed in claim 2 in which the national financial institution and the foreign financial institution both operate mutually compatible member activated financial transaction systems.

11. A cross-border financial transaction system as claimed in claim 2 in which a two-way facility is provided in which the national financial institution has a funding account in its server facility that is to be debited in consequence of transactions that may take place in the reverse direction, and the national banking institution is allocated an account to receive funds in the server facility of the foreign banking institution.

12. A method of conducting cross-border financial transactions utilising a system as claimed in claim 2 comprising the steps of receiving at a local banking institution in which a system member has an account an instruction communicated to it by means of a remote communications device to conduct a cross-border financial transaction; reserving by way of the computerised server facility the relevant funds from the instructing system member's account; communicating information concerning the financial transaction to the foreign financial institution and receiving a report from the foreign financial institution reporting as to the success, or otherwise of the transaction; and, in the event that the report is positive in that it confirms transfer of the relevant funds in the relevant foreign currency to the beneficiary, then transferring the reserved funds to the credit of the account of the foreign financial institution, and, in the event that the report is negative in that it reports that the funds were not transferred to the beneficiary, then cancelling the reservation of the funds or returning the reserved funds to the account of the instructing system member, as may be appropriate.
